(19) United States
(12) Patent Application Publication
(10) Pub. No.: US 2020/0207662 A1
(43) Pub. Date: Jul. 2, 2020

(54) METHOD FOR PRODUCING A MOLDING FROM A DRY MIXTURE COMPRISING GRAPHITE PARTICLES AND MOLDING THUS PRODUCED

(71) Applicant: kipan GmbH, Naila (DE)

(72) Inventor: Angela KIPFELSBERGER, Naila (DE)

(21) Appl. No.: 16/616,103

(22) PCT Filed: Apr. 27, 2018
(86) PCT No.: PCT/EP2018/060861

§ 371 Date: Nov. 22, 2019

(30) Foreign Application Priority Data
May 26, 2017 (DE) 10 2017 208 905.9
Mar. 29, 2018 (EP) 18164984.9

(51) Int. Cl. C04B 14/02; C04B 28/10; C04B 28/00; C04B 28/12; C04B 28/30

(52) U.S. Cl. CPC C04B 14/024; C04B 28/105; C04B 2111/00181; C04B 28/12; C04B 28/30; C04B 28/001

(57) ABSTRACT

Lightweight molding produced from a dry mixture including graphite particles and a binder for setting of the dry mixture by water, alkali and/or aqueous salt solution, where the proportion by mass of the graphite particles in the dry mixture is more than 0.05, the binder includes magnesia binder, cement, caustic calcined magnesite, lime and/or clay powder, the density of the lightweight molding is in the range from 0.1 g/cm³ to 3.5 g/cm³ and the lightweight molding has a thermal conductivity of at least 0.5 W/mK.

### CROSS REFERENCE TO RELATED APPLICATIONS

This application is a United States National Phase Application of International Application PCT/EP2018/060861 filed Apr. 27, 2018 and claims the benefit of priority under 35 U.S.C. § 119 of German Patent Application, Serial No. DE 10 2017 208 905.9, filed on May 26, 2017, and European Patent Application, Serial No. EP 18 164 984.9, filed on Mar. 29, 2018, the entire contents of each application are incorporated herein by reference.

### FIELD OF THE INVENTION

The invention relates to a lightweight molding produced from a dry mixture comprising graphite particles, a sandwich component and also method for producing a lightweight molding from such a dry mixture.

### BACKGROUND OF THE INVENTION

A binder-free lightweight graphite plate produced exclusively from expanded graphite flocs and in particular without any addition of binders is known. This lightweight graphite plate is mechanically unstable and not readily useable as semifinished part, e.g. for building applications. The use of graphite as aggregate for a component in order, for example, to increase the thermal conductivity thereof is known. In the case of the component known from the prior art, a rock particle fraction composed of, for example, basalt or silica sand is used to provide a concrete system, a screed system and/or a mortar system which is processable and/or handleable. Graphite is known as aggregate for polymer systems, for example in the form of polymers comprising graphite powder to improve the thermal conductivity and/or to improve the electromagnetic shielding action.

The use of graphite particles for building material mixtures is known from WO 2016/087 673 A1, from DE 103 06 473 A1, from DE 35 078 77 C2, from DE 10 2011 007 843 and from DE 11 2004 002 724 T5.

EP 1 065 451 A2 discloses a graphite-containing fill material as heat transfer in the earth.

### SUMMARY OF THE INVENTION

It is an object of the present invention to make better use of the advantageous materials properties of graphite for applications, in particular of building materials, construction materials and in particular lightweight elements and sandwich components produced therefrom, in order to achieve improved heat transport, better heat storage and also an improved electrical conductivity and/or an improved electromagnetic shielding action.

This object is achieved according to the invention by a lightweight molding produced from a dry mixture comprising graphite particles and a binder for setting of the dry mixture by means of water, alkali and/or aqueous salt solution, where the proportion by mass of the graphite particles in the dry mixture is more than 0.05, wherein the binder comprises magnesia binder, cement, caustic calcined magnesite, lime and/or clay powder, the density of the lightweight molding is in the range from 0.1 g/cm³ to 3.5 g/cm³, the lightweight molding has a thermal conductivity of at least 0.5 W/mK.

This object is further achieved by a sandwich component comprising a construction element having at least one hollow space, with a dry mixture having been introduced into the at least one hollow space and set to form an inventive lightweight molding. The sandwich component is configured as three-layer composite element with a centrally arranged element in the form of an inventive lightweight molding.

Further, this object is achieved by a method for producing a lightweight molding comprising the process steps: introduction of a dry mixture comprising graphite particles and also cement, magnesia binder, caustic calcined magnesite, lime and/or clay powder as binder, where the proportion by mass of the graphite particles in the dry mixture is more than 0.05, into a mold, setting of the dry mixture by means of water, alkali and/or aqueous salt solution, removal of the molding from the mold. Another method for producing a lightweight molding uses a mold-free production process, in particular 3D printing.

According to the invention, it has been recognized that graphite can advantageously be used not as aggregate but as main constituent of a dry mixture. Graphite, i.e. carbon, has a very high thermal conductivity and electrical conductivity. The further advantageous physical and chemical properties, in particular the high heat resistance, the ability to absorb and release moisture and also the low particle density and the pronounced inert character, of this material can be utilized for a dry mixture and the moldings produced therefrom.

A lightweight molding can, in particular, be a cement-bonded graphite component having a high thermal conductivity and/or high heat capacity and in particular can have advantageous properties in respect of shielding against electromagnetic radiation.

The lightweight molding can also serve to conduct and/or store electric power.

The molding is not combustible and has essentially no thermal expansion.

A lightweight molding has a particularly high thermal conductivity of at least 0.5 W/mK. The thermal conductivity of the lightweight molding is, in particular, at least 0.7 W/mK, in particular at least 1.0 W/mK, in particular at least 1.5 W/mK, in particular at least 2.0 W/mK, in particular at least 2.3 W/mK, in particular at least 2.5 W/mK, in particular at least 3.0 W/mK, in particular at least 3.5 W/mK, in particular at least 4.0 W/mK and in particular at least 4.5 W/mK.

It is important that the lightweight molding made from a dry mixture in a simple composition comprises exclusively graphite particles and a binder, i.e. further aggregates are dispensable.

The lightweight molding produced according to the invention displays, in particular, a high UV resistance. The UV resistance of the molding is comparable to that of a concrete element which is exposed to the environment, i.e. the rays of the sun.

The lightweight molding has a high mechanical strength. The mechanical strength, in particular the compressive strength, of the molding is determined essentially by the graphite particles used and the binders. The compressive strength is, in particular, in the range from 0.02 N/mm² to 50 N/mm².

A molding having a density in the range from 0.1 g/cm³ to 3.5 g/cm³, in particular in the range from 0.1 g/cm³ to 2.9 g/cm³, in particular from 0.1 g/cm³ to 2.5 g/cm³, in particular from 0.1 g/cm³ to 2.0 g/cm³, in particular from 0.5 g/cm³ to 2.0 g/cm³, is considered to be a lightweight molding. It is advantageous that the density of the molding is adjustable in a targeted manner. When specialty cements having high pure densities and heavy aggregates such as barite, magnetite or hematite are used, very high densities of the molding can be achieved even in the case of self-densifying setting of the dry mixture with water by means of gravity, i.e. without action of additional densifying energy. With the additional use of densifying energy by means of, for example, shaking, stamping, pressing, it is possible to achieve densities of greater than 3.5 g/cm³. In combination with the high molding density, the compressive strength of the molding can also increase to 100 N/mm² and above.

The natural graphite influences first and foremost the thermal conductivity and the electrical conductivity and the shielding against electromagnetic radiation of the dry mixture or of the lightweight molding.

Particularly when milled natural graphite, expanded graphite flocs and/or milled graphite from graphite sheets is used, the particle density is not more than from 2.0 g/cm³ to 2.3 g/cm³.

The low bulk density of natural graphite of, in particular, less than 700 g/l brings about a reduced density of the dry mixture. In the case of natural graphite having an average particle size of 200 μm and a carbon content of 97%, the bulk density is in the range from 85 g/l to 125 g/l, in particular from 100 g/l to 110 g/l. In the case of natural graphite having particle sizes in the range from 0 mm to 5 mm, the bulk density is in the range from 150 g/l to 230 g/l, in particular from 180 g/l to 200 g/l.

The bulk densities for milled natural graphite are preferably in the range from 10 g/l to 700 g/l and for expanded graphite flocs are in the range from 2 g/l to 20 g/l. Natural graphite can be mechanically worked advantageously, in particular by sawing and/or drilling, with the good mechanical processability also having been carried over to the lightweight molding produced from the dry mixture.

Synthetic graphite makes it possible to improve the mechanical properties, in particular on the basis of a high strength.

It is advantageous for the synthetic graphite to have an Mohs hardness of more than 6, in particular more than 7 and in particular in the range from 8 to 9. When synthetic graphites are used, the density can also be more than 2.3 g/cm³. The bulk density of synthetic graphite is, in particular, greater than 700 g/l.

In the case of synthetic graphites having particles which have a particle size of greater than 4 mm, the bulk density is in the range from 920 g/l to 940 g/l, in particular 925 g/l, in a particle size range from 1.25 mm to 4.0 mm the bulk density is in the range from 890 g/l to 920 g/l, in particular 905 g/l, in a particle size range from 0.8 mm to 1.25 mm the bulk density is in the range from 840 g/l to 870 g/l, in particular 856 g/l, in a particle size range from 0.4 mm to 0.8 mm is in the range from 830 g/l to 840 g/l, in particular 835 g/l, and in a particle size range of less than 0.4 mm is in the range from 700 g/l to 720 g/l, in particular 709 g/l.

Due to the increased mechanical strength, it is possible to place pegs in a drilled hole in a molding made of synthetic graphite and dissipate greater loads into the molding.

The inorganic binder requires mixing water in order to set the dry mixture. It has been recognized according to the invention that the graphite particles are not necessary for the binding process. Depending on the binder used, for example lime, magnesia, clay powder and/or cement, setting of the binder can occur independently of the graphite particles. The graphite particles are fixed to one another and thereby bound to one another by means of the binder. The proportion by mass of the graphite particles in the dry mixture can be selected essentially freely and is more than 0.05. The graphite particles can form a main constituent of the dry mixture. In particular, the proportion by mass of the graphite particles is at least 0.10, in particular at least 0.20, in particular at least 0.25, in particular at least 0.30, in particular at least 0.50 and in particular at least 0.80.

In particular, the proportion by mass of binder in the dry mixture is more than 0.05, in particular at least 0.25, in particular at least 0.40, in particular at least 0.50, in particular at least 0.55, in particular at least 0.60, in particular at least 0.65, in particular at least 0.70, in particular at least 0.80, in particular at least 0.90 and in particular not more than 0.95.

A molding which has satisfactory mechanical strength can be produced from the dry mixture.

The binder which, preferably mixed with water, makes binding of the graphite particles possible is simple to process and is, in particular, suitable for direct use on the building site for manual production of a component and for batchwise or continuous production of moldings in a manufacturing facility.

An inorganic binder, in particular cement, which can also be provided, for example, with admixtures and additives and optionally with fibers, in particular Portland cement, Portland composite cement, blast furnace slag cement, pozzolanic cement, composite cement and/or specialty cements such as white cements or hydrophobicized cements, is known to a skilled person in the field of building applications. Handling is uncomplicated and not susceptible to errors. The inorganic binder, in particular cement, also serves as heat storage. A molding produced from the dry mixture comprising cement can have an advantageous heat storage capacity.

For the purposes of the present invention, admixtures are, for example, concrete plasticizers, fluidizers, foam formers and retarders. Additives are, for example, quartz flour, pigments, trass, silica dust and fly ash.

Further inorganic binders can be lime, for example in the form of building lime, air-hardening lime or hydraulic limes, or magnesia binder, a binder composed of magnesium oxide and soluble magnesium salts such as magnesium chloride or caustic magnesia derived from, for example, burnt magnesite. It is likewise possible to use ashes such as fly ashes and volcanic ashes as binders, preferably in combination with cement, or clay powder.

The bulk density of standard cement as hydraulic binder is from about 900 g/l to 1200 g/l, in particular from 1000 g/l to 1200 g/l, for lime is about 600 g/l-1400 g/l, in particular from 800 g/l to 1000 g/l, for magnesite is from about 1000 g/l to 1200 g/l and for clay powder is from about 1200 g/l to 1400 g/l.

It is also possible to combine a plurality of inorganic binders with one another.

For the purposes of the present invention, a dry mixture is a system which comprises graphite particles and a binder, which are mixed to produce a molding.

The binder ensures reliable and mechanically robust binding of the graphite particles. The dry mixture is suitable for producing a mechanically stable molding. The dry mixture can also be present in unmixed form in the as-delivered state, in which the graphite particles are separate from the binder and mixing of the graphite particles with the binder occur only on site, in particular on a building site and/or a molding manufacturing works.

The dry mixture can, depending on the binder used, be considered to be ecologically advantageous and can be environmentally friendly, unproblematical in terms of health and not combustible.

The dry mixture has, in particular, a high resistance to chemical reagents, in particular acids and/or alkalis, and environmental influences.

The dry mixture can, in particular, be a cement-bonded render and/or knifing filler with milled graphite, which can be applied directly to structures, for example a wall. A mold for producing a lightweight molding is then dispensable.

The properties of the dry mixture and thus a lightweight molding produced from this dry mixture can fundamentally be set specifically and in accordance with the use by targeted addition of functional additives, in particular at least one thermal additive, at least one electrical additive or at least one structural additive or any mixture thereof. There are wide range limits for the materials parameters to be achieved. The dry mixture is versatile and can be used flexibly.

A lightweight molding has, in particular, isotropic materials properties. It is possible to set anisotropic, i.e. directional, materials properties by means of addition of functional additives. It is also conceivable to arrange individual functional additives either homogeneously or inhomogeneously in the dry mixture and in particular in the mold for producing the molding in order to produce locally different materials properties.

A lightweight molding produced from a dry mixture comprising graphite particles and a binder for setting of the dry mixture by means of water, alkali and/or aqueous salt solution, where the proportion by mass of the graphite particles in the dry mixture is more than 0.05, wherein the binder comprises magnesia binder, cement, caustic calcined magnesite, lime and/or clay powder, the density of the lightweight molding is in the range from 0.1 g/cm³ to 3.5 g/cm³, the lightweight molding has a thermal conductivity of at least 0.5 W/mK having an adjustable density, an improved water absorption and release capability, a high thermal conductivity and heat storage capacity, an increased electrical conductivity, improved screening against electromagnetic radiation, a reduction of magnetic field strengths, a high chemical resistance, improved fire protection and improved acoustic protection by means of an adjustable porosity can be produced as a function of the mixing ratio of graphite particles to binder, in particular cement.

Grain-shaped and/or fiber-shaped graphite particles allow advantageous setting of the materials properties of the lightweight moldings produced therefrom as a function of the geometry of the graphite particles. It is conceivable to mix grain-shaped particles and/or fibrous particles. In addition or as an alternative, graphite can be used in powder form, for example as graphite powder. The particle size of the graphite powder particles is not more than 1.0 μm. The graphite powder particles are referred to as nanoparticles. In particular, it has been recognized that any particle geometry is fundamentally suitable for use in the dry mixture. This opens up a particularly wide field of use of graphite particles.

Graphite particles having a particle size in the range from 0.1 μm to 100 mm, in particular from 1.0 μm to 40 mm, in particular from 5 μm to 25 mm, in particular from 10 μm to 10 mm and in particular from 200 μm to 5 mm make a broad range of uses possible. The particle size, which is also referred to as grain size, is not limited in respect of its minimum size. It is possible to use nanoparticles which by definition have a particle size of less than 100 μm.

The use of graphite particles, which have been produced from natural and/or synthetic graphite, in particular from expanded graphite flocs, milled graphite flocs, milled graphite foils, milled natural graphite and/or milled synthetic graphite, makes particularly wide use possible. In particular, it is inconsequential whether the graphite particles have been produced from natural or synthetic graphite. It has been recognized that, for example, particulate graphite in the form of natural graphite as powder from graphite ore and/or graphite-containing rock can be used. In addition or as an alternative, it is possible to use graphite salt, i.e. graphite powder with an intercalated acid, for example sulfuric acid or phosphoric acid. Graphite salt is preferably mixed with a cement slurry and heated, as a result of which the graphite salt is foamed. It is also conceivable to use expanded natural graphite, i.e. graphite flocs. It is also possible to use milled natural graphite, i.e. in powder form, as graphite particles for the purposes of the invention. The milled material can be obtained from synthetic graphite and/or from natural graphite in the form of graphite sheets and/or lightweight graphite plates, i.e. recycled material. This milled material preferably has a powder particle size in the range from 1 μm to 10 mm. The milled material has improved processing properties compared to the expanded graphite flocs. The process engineering outlay in the production of the dry mixture and/or a molding produced therefrom is reduced. It is also conceivable to use milled material derived from synthetic graphite, in particular from pitch and/or coke, copper-infiltrated graphite and in particular electrode scrap. The particle size of this milled material is typically in the range from 1 μm to 50 mm, in particular from 100 μm to 10 mm and in particular from 200 μm to 5 mm. Fibrous graphite particles derived from graphite fibers or graphite foils, in particular in the form of foil strips and/or foil tapes can be used. These foil strips and/or foil tapes can also have a length greater than 100 mm.

The graphite particles which have been produced from coke, carbon blacks and activated carbon, include cokes, carbon blacks and activated carbon as a further carbon form of graphite.

At least one thermal additive for increasing the thermal conductivity and/or for increasing the heat storage capacity is present and makes it possible to improve the thermal properties of the dry mixture in a targeted manner. Thermal additives in the context of the invention are, for example, industrial carbon black, technical-grade carbon black, thermally conductive rock powder such as basalt powder, quartzite, barite, magnetite, hematite or ground shale, milled synthetic graphite, in particular electrode scrap, metal powder such as zinc powder, metallic fibers, fibrous or sheet-like structures composed of electrically conductive materials, for example woven copper meshes, and also phase-change materials (PCM). It is possible to use various thermal additives in the dry mixture.

At least one electrical additive for increasing the electrical conductivity, the electrical storage capacity, reducing the magnetic permeability and/or for improving the shielding against electromagnetic radiation, serves to improve the electrical properties, in particular the electrical conductivity and/or shielding against electromagnetic radiation. Electrical additives can be milled synthetic graphite, for example electrode scrap, powders composed of rock particle fractions such as magnesite rock, metal powders or pigments composed of copper, silver, zinc, metallic fibers, fibrous or sheet-like structures composed of electrically conductive materials, in particular metallic woven meshes such as woven copper meshes or woven carbon meshes, and/or formed-loop knitteds or drawn-loop knitteds.

A lightweight molding can have embedded electrically conductive threads, wires and/or electrical meshes in order to make active temperature control, in particular heating and/or cooling, of the molding possible.

At least one structural additive makes it possible to alter the structure of a molding produced from the dry mixture in a targeted manner. Depending on the structural additive introduced, it is possible, for example, to decrease the density or reduce the shrinkage. For example, strength-increasing structural additives can be provided close to the surface in the mold in order to make an improved mechanical strength of the molding produced in this way possible. Structural additives can be inorganic fibers such as metal fibers composed of aluminum, copper and/or silver, steel fibers, ceramic fibers, glass fibers, carbon fibers and/or basalt fibers. As an alternative or in addition, it is possible to use chemically produced fibers, in particular thermoplastic fibers, in particular fibers composed of polypropylene (PP), polyethylene (PE-LD, PE-HD), polyamide (PA 6, PA 66), polyester (PET), or natural fibers, in particular wood, straw, grass, reed and hemp fibers. It is also possible to produce homogeneous or hybrid sheet-like structures, for example woven fabrics, drawn-loop knitteds and/or formed-loop knitteds from these fibers and use them in the lightweight molding.

Spherical aggregates such as ground rock, in particular expandable clay, ground brick, loam powder, clay powder, gypsum, ground basalt, crushed brick, perlite, silica sand, short glass fibers or metal sand are also possible as structural additives. Spherical aggregates can also be lightweight materials such as Liapor, pumice, foamed lava or expanded shale, for example in order to decrease the density of the dry mixture and thus of a lightweight molding produced therefrom.

Spherical aggregates can also be polystyrene or glass spheres or any fine, normal or coarse or else light, normal or heavy rock particle fraction and mixtures thereof.

It is also possible to introduce any type of reinforcements, spacers and supports as structural additives into the lightweight molding. Functional elements such as mechanical hooks, in particular metal hooks, metal islets, angle irons, perforated iron parts, anchors, pins, screws, threaded rods, rails or electrically conductive connections such as wires can likewise be embedded.

It is also possible to integrate profile elements as structural additives in the lightweight molding, in particular for protecting the edges of a plate-like molding. It is also possible to integrate connecting elements in order to be able to join the molding as one layer more easily to other layers in a sandwich component.

A lightweight molding, wherein the dry mixture consists exclusively of graphite particles and cement, is in particular uncomplicated to produce. Functional additives are dispensable. The materials properties of the dry mixture and the lightweight moldings produced therefrom are set in particular by the mixing ratio of graphite particles and binder, with, in particular, the choice of the graphite particles, in particular the particle size thereof, the particle shape thereof and the original parent material from which the graphite particles have been produced, exerting an influence on the properties. In particular, the use of a rock particle size fraction as is by definition required for the production of concrete is dispensable.

A lightweight molding has an advantageous shielding action against electromagnetic radiation, which is, in particular, at least 80%, in particular at least 90%, in particular at least 99%, in particular at least 99.99% and in particular at least 99.9999%. Such a molding is particularly advantageous for applications in which building biological aspects are of significance. The shielding action occurs, in particular, in a wavelength range from 50 Hz to 40 Ghz.

A sandwich component comprising a construction element having at least one hollow space, with a dry mixture having been introduced into the at least one hollow space and set to form an inventive lightweight molding can also be produced by using the hollow spaces of components, construction elements, masonry blocks and construction profiles, e.g. made of concrete, brick, Liapor, wood and/or polymer, as mold and curing the dry mixture mixed with water in this hollow space.

A sandwich component configured as three-layer composite element with a centrally arranged element in the form of an inventive lightweight molding is a three-layer composite element, in particular a composite plate having a centrically arranged plate of a molding according to the invention.

A sandwich component can be, for example, a concrete, loam, gypsum plasterboard, wood or brick plate or else a construction element or a masonry block composed of, for example, brick, sand-lime brick, porous concrete, lightweight concrete, chamotte, Liapor or an element composed of mineral insulation materials, industrial woven fabrics and nonwovens, wood and clinker.

A process comprising the steps: introduction of a dry mixture comprising graphite particles and also cement, magnesia binder, caustic calcined magnesite, lime and/or clay powder as binder, where the proportion by mass of the graphite particles in the dry mixture is more than 0.05, into a mold, setting of the dry mixture by means of water, alkali and/or aqueous salt solution, removal of the molding from the mold, allows particularly uncomplicated processing of the dry mixture to produce a molding. The molding is, in particular, a construction element. Owing to the fact that the binder sets in the presence of water, essentially no limits are imposed on shaping in the production of the molding. Depending on the mold made available, a molding can be produced with essentially any contours.

The dry mixture can likewise be processed using a mold-free production process such as 3D printing which makes a mold dispensable. This process makes it possible to produce both lightweight moldings, complex plant parts such as consoles for machine housings or else wall elements and buildings.

Working examples of the invention will be explained in detail below:

In an advantageous embodiment, a molding can be produced from the dry mixture in a continuous or batch production process, in particular in-situ on the building site. For use as knifing filler, the use of a mold is dispensable, as also in the use of an alternative production process such as 3D printing.

In a further advantageous embodiment, essentially free shaping can be carried out with the aid of selection of the molding. It is possible, in particular, to produce sheet-like molded elements in the form of plates of different plate size and/or plate thickness. Three-dimensionally shaped elements, in particular building blocks, pipes and/or profiles, can also be produced. The surfaces of the molding can be made smooth or structured.

A lightweight molding produced according to the invention is particularly suitable for manual processing, for example on the building site. The shaped element can also be processed by sawing and/or drilling as is known per se. Possible joining techniques are, in particular, adhesive bonding, use of knifing fillers or mortars and/or screws.

It has surprisingly been found that a molding produced from the dry mixture can, depending on the proportion of graphite, be adhesively bonded or joined to itself or to other materials by means of virtually all conventional adhesives, knifing fillers, plasters or renders and/or mortar systems.

Possible joining techniques also include mechanical clamping, riveting or snap connections. The molding can also be provided with a tongue/groove system in order to improve areal adjoining between moldings.

The lightweight moldings according to the invention open up a variety of applications in the building and construction sector, for example in tiled stove construction, in chimney construction, in the construction of areal heating/cooling systems, as cooling and heating elements in engineering of buildings, in plants and appliances such as freezers, as heat storages, for example in conjunction with phase-change materials (PCM), as solar module, as temperature-control module with embedded piping system and/or electric heating mats, as hot water storage, as battery system for storing electric energy.

A lightweight molding provided with thermal additives can be used, for example, in electric circuit boxes or in photovoltaic or solar modules for paneling and for heating/cooling the boxes and modules. Such a lightweight molding can also be used in the construction of dwellings, for example in order to absorb the heat of solar radiation and conduct it onward, or for the construction of areal heating or cooling systems or for controlling the heat management of plants and machines.

The use of the binder, in particular in combination with chamotte powder or phase-change materials, makes it possible to provide a molding which has a particularly high thermal conductivity and also a high heat storage capacity. In addition to or as an alternative to phase-change materials, synthetic graphite powder from electrode scrap and/or rock particle size fractions from hard rock such as basalt, granite and/or quartzite can also contribute to increasing the thermal conductivity and heat storage capability of the molding. In particular, the heat storage capacity of the molding can be set in a targeted manner as a function of the proportion of graphite and binder.

It is possible to embed further functional components such as meandering pipes and/or electrically conductive woven fabrics and/or phase-change materials (PCM) in the molding according to the invention. A molding having a heating/cooling function and/or heat storage function can be provided thereby.

The lightweight molding can, depending on the graphite particles used, be pore-free or with a porosity of up to 100%. Foaming additives and/or blowing agents are dispensable. A differing density distribution, comparable to a structured foam part as graphite integral component, can be achieved by blowing gases such as air or air constituents, for example nitrogen, into the mold.

It has surprisingly been found that the porosity of the moldings improves infiltration with liquid, in particular water. Such a molding is dispersion-open and is particularly suitable for use as building material in interior rooms of dwellings. The risk of foam formation is reduced. Moldings infiltrated with water can, for example, be frozen and thawed again for virtually any number of times without damage to the molding being observed. The porosity allows targeted incorporation of liquid, in particular for targeted setting of the functional properties of the molding.

The molding can, for example, also be infiltrated with oils and/or waxes.

The pore size of the lightweight molding can be set in a targeted manner as a function of the graphite used and/or the binder used. The pore sizes are in the range from 0.001 mm to 2.0 mm, in particular from 0.01 mm to 1 mm and in particular from 0.1 mm to 0.5 mm. Air pores based on, for example, synthetic surfactants or modified resins, e.g. tree resins, and also hollow microspheres as prefabricated air pores based on acrylonitrile polymers can be mixed in a targeted manner into the dry mixture or into the graphite/cement slurry, as can foam formers, for example based on organic surfactants or alkylarylsulfonates.

A lightweight molding can be produced using pigments, for example colored pigments, and/or be painted or varnished completely or at least in sections.

Lightweight moldings can also be surface-coated at least in sections and/or completely and/or have laminated-on layers, in particular in the form of woven fabrics, metallic foil, in particular aluminum foil, and/or a polymer film, for example polyethylene, which perform particular functions. For example, a water-infiltrated molding can be vacuum-packed in an aluminum foil. Such a molding is very suitable as cooling element.

Further suitable materials for coating the moldings are nonwovens, industrial textiles, papers, wood veneers, perforated sheets made of polymer or metal. These layer composites are advantageous because the mechanical stability of the molding can be increased thereby.

Heat-insulating coatings made of wood, cork, reed and polymers, e.g. expanded polystyrene, polyurethane, or mineral wool such as glass and rock wool or mineral foams such as foam concrete or lightweight concretes and also heat-insulating masonry blocks can be used in the composite in order to avoid possible heat losses. The coatings can, for example, also contribute to improving the visual appearance, acoustic insulation, footfall damping and/or reducing the impact sensitivity of the lightweight molding.

The surface of the lightweight molding can also be flocked with fibers composed of metal or polymers or be equipped for photocatalytic applications by incorporation of titanium dioxide.

Table 1 below shows examples of dry mixtures according to the invention and the physical properties thereof.

The density values reported in table 1 relate to a graphite dry mixture which has been mixed with water to form a slurry. The density of the slurry was determined without densification of the composition, for example by shaking, tamping or rolling. A molding produced from the graphite dry mixture by pressing or shaking can have a correspondingly increased density due to densification of the slurry. This means that there are further adjustment possibilities during production of the molding for adapting the physical materials properties of the molding. In particular, it is possible to produce a molding having locally adapted materials properties, in particular a locally different density distribution.

It is immediately clear from table 1 that the dry mixture according to the invention makes it possible to produce a molding having a very variable density range. Simply mixing the graphite particles with cement and water is necessary for this purpose. Lightweight aggregates such as expanded clay or pumice, as are used in the production of lightweight concrete, are dispensable for the purposes of the invention.

TABLE 1
Examples of dry mixtures

| | | | | Mass of graphite | Mass of added | | | |
|---|---|---|---|---|---|---|---|---|
| | | | Particle | particles based | water based on | | Water | |
| | | | size | on dry mixture | dry mixture | Density | absorption | Porosity |
| No. | Graphite type | | [mm] | [%] | [%] | [g/cm³] | [ml] | [%] |
| 1 | Synthetic graphite | | 1.25-4.0 | 44 | 22 | 2.00 | 14 | 1.70 |
| 2 | Synthetic graphite | | 0.8-1.25 | 44 | 22 | 2.06 | 16 | 2.01 |
| 3 | Synthetic graphite | | 0-0.4 | 50 | 31 | 1.74 | 23 | 3.12 |
| 4 | Natural graphite | | 0-5.0 | 33 | 66 | 1.23 | 93 | 12.32 |
| 5 | Natural graphite | | 0-5.0 | 43 | 86 | 1.09 | 109 | 33.13 |
| 6 | Natural graphite | | 0-5.0 | 56 | 44 | 0.76 | 384 | 55.98 |
| 7 | Natural graphite | | 97/200 | 42 | 158 | 0.63 | 228 | 75.75 |
| 8 | Natural graphite | | 97/200 | 50 | 200 | 0.49 | 172 | 93.48 |
| | Natural graphite | | 97/200 | | | | | |
| | | {close oversize brace} | | | | | | |
| 9 | Natural graphite | | 0-5.0 | 47 | 123 | 0.85 | 119 | 31.07 |
| | Synthetic graphite | | 0.4-0.8 | | | | | |
| | Natural graphite | | 97/200 | | | | | |
| | | {close oversize brace} | | | | | | |
| 10 | Natural graphite | | 0-5.0 | 47 | 116 | 0.78 | 131 | 51.37 |
| | Synthetic graphite | | 0.4-0.8 | | | | | |
| | Natural graphite | | 97/200 | | | | | |
| | | {close oversize brace} | | | | | | |
| 11 | Natural graphite | | 0-5.0 | 43 | 88 | 0.93 | 58 | 32.04 |
| | Synthetic graphite | | 1.25-4.0 | | | | | |
| | Natural graphite | | 0-5 | | | | | |
| | Synthetic graphite | | 0.4-0.8 | | | | | |
| 12 | Synthetic graphite | {close oversize brace} | 0.8-1.25 | 55 | 45 | 1.20 | 42 | 17.00 |
| | Synthetic graphite | | 1.25-4.0 | | | | | |
| | Synthetic graphite | | >4.0 | | | | | |

As tables 2 and 3 show, it is possible to produce lightweight materials and corresponding lightweight moldings which have a low density and at the same time an increased thermal conductivity.

In the case of masonry blocks and lightweight concrete bricks having a low density, the thermal conductivity is reduced because of the required use of lightweight aggregates such as expanded clay and pumice.

In addition, the lightweight moldings presented in tables 2 and 3 have an excellent shielding action against electromagnetic radiation and a very low electrical resistance.

According to the invention, the increased electrical conductivity of the lightweight moldings can also be significantly reduced or raised according to requirements by use of the graphite. This change in properties of the lightweight molding is due to the formation of a percolation network of graphite particles being suppressed by, for example, the use of a low water/cement value (w/c value for short) or the use of a smaller proportion by mass of larger graphite particles.

It can be seen from tables 2 and 3 that a lightweight molding according to the invention has a greater thermal conductivity compared to the present-day standard building materials and standard components of comparable density, with the thermal conductivity of the lightweight molding of the invention being, in particular, at least twice, in particular at least four times, in particular at least six times, in particular at least eight times and in particular at least ten times, the thermal conductivity of the standard building materials. In addition, the standard construction elements used at present do not have any shielding action in respect of electromagnetic radiation and do not have any electrical conductivity.

TABLE 2
Thermal conductivity of components
having a particularly low density

| | | Thermal |
|---|---|---|
| | Density | conductivity λ |
| Component, material | δ [g/cm³] | [W/mK] |
| Lightweight molding | 0.70 | 2.30 |
| according to the invention | | |
| Porous concrete, flat block | 0.70 | 0.23 |
| Solid block, natural pumice | 0.70 | 0.28 |
| Masonry block, expanded clay | 0.70 | 0.30 |
| Vertically cored brick | 0.70 | 0.30 |
| Lightweight concrete block | 0.80 | 0.38 |
| with porous aggregate | | |
| Tunnel wall | 0.70 | 0.19 |
| Slate | 2.60 | 2.30 |

The lightweight molding indicated in table 2 has been produced from the dry mixture corresponding to number 7 in table 1, which comprises milled natural graphite and cement. The cement is a Portland composite cement which in accordance with DIN EN 197 1 has the designation CEM II/A LL 32.5 R. This is a Portland composite cement comprising from 80% to 94% of Portland cement clinker and from 6% to 20% of limestone. The cement is indicated as being in the strength class 32.5, i.e. has a strength of 32.5 N/mm² after 28 days. The cement has a high initial strength, i.e. a rapid strength development which is indicated by the suffix “R”.

The measurement of the thermal conductivity was carried out in accordance with EN ISO 2007-2:2015.

TABLE 3
Thermal conductivity of components having a low density

| | | Thermal |
|---|---|---|
| | Density | conductivity λ |
| Component, material | δ [g/cm³] | [W/mK] |
| Lightweight molding | 1.20 | 4.50 |
| according to the invention | | |
| Lightweight concrete with | 1.20 | 0.46 |
| porous aggregates | | |
| Cored brick, full | 1.20 | 0.50 |
| Solid block, natural pumice | 1.20 | 0.54 |
| Solid block, lightweight | 1.20 | 0.54 |
| concrete | | |
| Sand-lime brick | 1.20 | 0.56 |
| Loam | 1.20 | 0.50 |
| Basalt | 3.00 | 3.50 |
| Granite, marble | 2.80 | 3.50 |

The lightweight molding reported in table 3 has been produced from the dry mixture corresponding to the mixture 12 in table 1, which comprises milled natural graphite and cement having the designation CEM II/A-LL 42.5 N. In contrast to the cement of the lightweight molding in table 2, this cement has a higher strength class of 42.5 N/mm² after 28 days with a normal initial strength, i.e. normal strength development having the designation “N”.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

1. A lightweight molding produced from a dry mixture comprising graphite particles and a binder for setting of the dry mixture by at least one of water, alkali and aqueous salt solution, wherein a proportion by mass of the graphite particles in the dry mixture is more than 0.05, the binder comprising at least one of magnesia binder, cement, caustic calcined magnesite, lime and clay powder, wherein a density of the lightweight molding is in a range from 0.1 g/cm³ to 3.5 g/cm³, the lightweight molding having a thermal conductivity of at least 0.5 W/mK.

2. The lightweight molding as claimed in claim 1, wherein the graphite particles are at least one of grain-shaped and fiber-shaped.

3. The lightweight molding as claimed in claim 1, wherein the graphite particles have a particle size in the range from 0.1 μm to 100 mm.

4. The lightweight molding as claimed in claim 1, wherein the graphite particles are produced from at least one of natural graphite, synthetic graphite, expanded graphite flocs, milled graphite flocs, milled graphite foils, milled natural graphite and milled synthetic graphite.

5. The lightweight molding as claimed in claim 1, wherein the graphite particles are produced from coke, carbon blacks and activated carbon.

6. The lightweight molding as claimed in claim 1, wherein at least one thermal additive for at least one of increasing the thermal conductivity and for increasing the heat storage capacity is present.

7. The lightweight molding as claimed in claim 1, further comprising at least one electrical additive for at least one of increasing the electrical conductivity, increasing the electrical storage capacity, reducing the magnetic permeability and improving shielding against electromagnetic radiation.

8. The lightweight molding as claimed in claim 1, further comprising at least one structural additive for altering the structure of a molding produced from the dry mixture.

9. The lightweight molding as claimed in claim 1, wherein the dry mixture consists exclusively of graphite particles and cement.

10. The lightweight molding as claimed in claim 1, further comprising a shielding against electromagnetic radiation of at least 80%.

11. A sandwich component comprising a construction element having at least one hollow space, with a dry mixture introduced into the at least one hollow space and set to form a lightweight molding, the lightweight molding being produced from a dry mixture comprising graphite particles and a binder for setting of the dry mixture by at least one of water, alkali and aqueous salt solution, wherein a proportion by mass of the graphite particles in the dry mixture is more than 0.05, the binder comprising at least one of magnesia binder, cement, caustic calcined magnesite, lime and clay powder, wherein a density of the lightweight molding is in a range from 0.1 g/cm³ to 3.5 g/cm³, the lightweight molding having a thermal conductivity of at least 0.5 W/mK.

12. A sandwich component configured as three-layer composite element with a centrally arranged element in a form of a lightweight molding, the lightweight molding being produced from a dry mixture comprising graphite particles and a binder for setting of the dry mixture by at least one of water, alkali and aqueous salt solution, wherein a proportion by mass of the graphite particles in the dry mixture is more than 0.05, the binder comprising at least one of magnesia binder, cement, caustic calcined magnesite, lime and clay powder, wherein a density of the lightweight molding is in a range from 0.1 g/cm³ to 3.5 g/cm³, the lightweight molding having a thermal conductivity of at least 0.5 W/mK.

13. A method for producing a lightweight molding, the method comprising the process steps:
introducing a dry mixture comprising graphite particles and at least one of cement, magnesia binder, caustic calcined magnesite, lime and clay powder as binder, where a proportion by mass of the graphite particles in the dry mixture is more than 0.05, into a mold;
setting of the dry mixture by at least one of water, alkali and aqueous salt solution;
removing the molding from the mold.

14. A method, comprising:
producing a lightweight molding via a mold-free production process, the lightweight molding being produced from a dry mixture comprising graphite particles and a binder for setting of the dry mixture by at least one of water, alkali and aqueous salt solution, wherein a proportion by mass of the graphite particles in the dry mixture is more than 0.05, the binder comprising at least one of magnesia binder, cement, caustic calcined magnesite, lime and clay powder, wherein a density of the lightweight molding is in a range from 0.1 g/cm³ to 3.5 g/cm³, the lightweight molding having a thermal conductivity of at least 0.5 W/mK.

15. The method as claimed in claim 14, wherein the mold-free production process comprising 3-D printing.
